(19) United States
(12) Patent Application Publication
(10) Pub. No.: US 2023/0390837 A1
(43) Pub. Date: Dec. 7, 2023

(54) COPING SYSTEM

(71) Applicant: MILWAUKEE ELECTRIC TOOL CORPORATION, Brookfield, WI (US)

(72) Inventors: Kyle Reeder, Waukesha, WI (US); James Wekwert, Whitefish Bay, WI (US); Daniel M. Blau, Milwaukee, WI (US); Daniel L. Parr, IV, Greendale, WI (US); Ryan M. McManus, Brookfield, WI (US); Jacob R. Seifert, Lake Mills, WI (US)

(21) Appl. No.: 18/203,716

(22) Filed: May 31, 2023

Related U.S. Application Data
(60) Provisional application No. 63/486,302, filed on Feb. 22, 2023.
(60) Provisional application No. 63/386,038, filed on Dec. 5, 2022.
(60) Provisional application No. 63/398,073, filed on Aug. 15, 2022.
(60) Provisional application No. 63/348,548, filed on Jun. 3, 2022.

(51) Int. Cl. B23D 45/14; B23D 47/08; B23D 45/00

(52) U.S. Cl. CPC B23D 45/14; B23D 47/08; B23D 45/003

(57) ABSTRACT

A power tool used to perform a coping cut including a main housing, a motor disposed within the main housing, a drive shaft driven by the motor about a rotational axis, a handle extending from the main housing, and an abrasive disc coupled to and driven by the drive shaft about the rotational axis. The motor is an outer rotor brushless direct current motor capable of rotating at 4,000 surface feet per minute at 1.5 inch-pounds of torque.

### CROSS-REFERENCE TO RELATED APPLICATIONS

This application claims priority to U.S. Provisional Patent Application No. 63/486,302, filed Feb. 22, 2023, U.S. Provisional Patent Application No. 63/386,038, filed Dec. 5, 2022, U.S. Provisional Patent Application No. 63/398,073, filed Aug. 15, 2022, and U.S. Provisional Patent Application No. 63/348,548, filed Jun. 3, 2022, the entire contents of all of which are incorporated herein by reference.

### FIELD OF THE INVENTION

The present invention relates to power tools, and more particularly to coping tools.

### BACKGROUND OF THE INVENTION

Coping is a technique used to join two pieces of wood trim at a variety of angles. The technique, which consists of removing material along the contours of a leading edge of the trim, has been proven effective when corners are not square.

### SUMMARY OF THE INVENTION

The invention provides, in on aspect, a power tool used to perform a coping cut including a main housing, a motor disposed within the main housing, a drive shaft driven by the motor about a rotational axis, a handle extending from the main housing, and an abrasive disc coupled to and driven by the drive shaft about the rotational axis. The motor is an outer rotor brushless direct current motor capable of rotating at 4,000 surface feet per minute at 1.5 inch-pounds of torque.

The invention provides, in another aspect, a coping tool including a main housing, a motor disposed within the main housing that rotates about a rotational axis, a handle extending from the main housing, an abrasive disc coupled to and driven by the drive shaft about the rotational axis, and a dust shroud coupled to the main housing and disposed at least partially around the abrasive disc. The dust shroud includes a channel extending along the dust shroud adjacent the abrasive disc and a cut zone opening through which a workpiece may pass to engage the abrasive disc. The channel is U-shaped and surrounds an outer periphery of the abrasive disc. The cut zone opening is adjustable in size and/or shape to accommodate the workpiece.

The invention provides, in another aspect, a coping tool including a main housing, a motor disposed within the main housing that rotates about a rotational axis, a handle extending from the main housing, an abrasive disc coupled to and driven by the drive shaft about the rotational axis, a fan disposed within the main housing and configured to induce an airflow, and a dust shroud pivotably coupled to the main housing and disposed at least partially around the abrasive disc. The dust shroud includes a channel extending along the dust shroud and a cut zone opening through which a workpiece may pass to engage the abrasive disc. The cut zone opening is adjustable in size and/or shape in response to the dust shroud pivoting between a first position and a second position.

Other features and aspects of the invention will become apparent by consideration of the following detailed description and accompanying drawings.

### BRIEF DESCRIPTION OF THE DRAWINGS

FIG. 1 is a perspective view of a coping system in accordance with an embodiment of the invention.

FIG. 2 is a side view of a portion of the coping system of FIG. 1.

FIG. 3 is a perspective view of a coping system in accordance with another embodiment of the invention.

FIG. 4 is another perspective view of the coping system of FIG. 3, illustrating the coping system coupled to a saw stand.

FIG. 5A is a top view of the coping system of FIG. 3 in a first position.

FIG. 5B is a top view of the coping system of FIG. 3 in a second position.

FIG. 6 is a front, perspective view of a coping system in accordance with another embodiment of the invention.

FIG. 7 is another perspective view of the coping system of FIG. 6.

FIG. 8 is an enlarged perspective view of a cutting attachment for a coping tool in accordance with an embodiment of the invention for use with the coping system of FIG. 6.

FIG. 9 is a side view of a cutting attachment for a coping tool in accordance with another embodiment of the invention for use with the coping system of FIG. 6.

FIG. 10 is a top view of a workpiece with a coping cut.

FIG. 11 is a perspective view of a coping system in accordance with another embodiment of the invention.

FIG. 12 is a plan view of a joystick apparatus for use with the coping system of FIG. 11.

FIG. 13 is a perspective view of a coping system in accordance with another embodiment of the invention, illustrating a coping tool with a barrel-grip style handle.

FIG. 14A is a perspective view of the coping system of FIG. 13, illustrating the coping tool having a palm-sander style handle.

FIG. 14B is a perspective view of the coping system of FIG. 13, illustrating the coping tool having a compact or low style handle.

FIG. 14C is a perspective view of the coping system of FIG. 13, illustrating the coping tool having a pistol-grip style handle.

FIG. 14D is a perspective view of the coping system of FIG. 13, illustrating the coping tool having an obliquely angled handle.

FIG. 14E is a perspective view of the coping system of FIG. 13, illustrating the coping tool having a wing style handle.

FIG. 15 is a perspective view of the coping system of FIG. 13, illustrating a motor housing coupled to the barrel-grip style handle.

FIG. 16A is a cross-sectional view of the coping system along line 16A-16A of FIG. 15, illustrating a drive mechanism at least partially disposed within the motor housing.

FIG. 16B is a cross-sectional view of the coping system along line 16B-16B of FIG. 15, illustrating the drive mechanism at least partially disposed within the motor housing and an airflow channel.

FIG. 17 is a side view of the coping system of FIG. 13, illustrating a motor axis and a workpiece support plane defined by the motor housing.

FIG. 18 is an enlarged front view of the coping system of FIG. 13, illustrating a first support surface and a second support surface angled relative to the workpiece support plane.

FIG. 19A is a perspective view of a coping system in accordance with another embodiment of the invention, illustrating a coping tool with a sanding disc proximate a handle.

FIG. 19B is a view of a sanding disc in accordance with another embodiment of the invention for the coping system of FIG. 19A.

FIG. 20 is a perspective view of a coping system in accordance with another embodiment of the invention, illustrating a coping tool with a cutting attachment and a dust shroud that surrounds a portion of the cutting attachment for collecting dust and debris.

FIG. 21 is a cross-sectional view of the coping system along line 21-21 of FIG. 20, illustrating an outer rotor BLDC motor.

FIG. 22 is another perspective view of the coping system of FIG. 20, illustrating a dust shroud that includes a series of segments that are movable.

FIG. 23 is another cross-sectional view of the coping system of FIG. 20, illustrating a fan being coupled to the cutting attachment

FIG. 24 is a perspective of a coping system in accordance with another embodiment of the invention, illustrating a coping tool with a cutting attachment and a dust shroud that pivots relative to the cutting attachment.

FIG. 25 is a cross-sectional view of the coping system along line 25-25 of FIG. 24, illustrating the dust shroud in a first position.

FIG. 26 is a cross-sectional view of the coping system along line 25-25 of FIG. 24, illustrating the dust shroud in a second position.

FIG. 27 is a perspective view of a coping system in accordance with another embodiment of the invention, illustrating a coping tool with a sanding belt proximate a handle and a vacuum shroud for removing dust and debris.

FIG. 28 is another perspective view of the coping system of FIG. 27, illustrating a belt assembly driving the sanding belt to expose a cutting area.

FIG. 29A is a perspective view of a coping system in accordance with another embodiment of the invention.

FIG. 29B is a plan view of a roughing gauge for the coping system of FIG. 29A.

FIG. 29C is a plan view of the coping system of FIG. 29A on a stand.

FIG. 29D is a plan view of a templating guide for the coping system of FIG. 29A.

FIG. 30 is a perspective view of a coping system in accordance with another embodiment of the invention.

FIG. 31 is a perspective view of the coping system of FIG. 30, illustrating a workpiece being analyzed by a sensor of the coping system.

FIG. 32 is an enlarged view of the coping system of FIG. 30, illustrating a coping operation being automatically performed on a workpiece.

Before any embodiments of the present disclosure are explained in detail, it is to be understood that the embodiments described herein are not limited in scope or application to the details of construction and the arrangement of components set forth in the following description or as illustrated in the following drawings. The devices described herein are capable of other embodiments and of being practiced or of being carried out in various ways. Also, it is to be understood that the phraseology and terminology used herein is for the purpose of description and should not be regarded as limiting.

### DETAILED DESCRIPTION

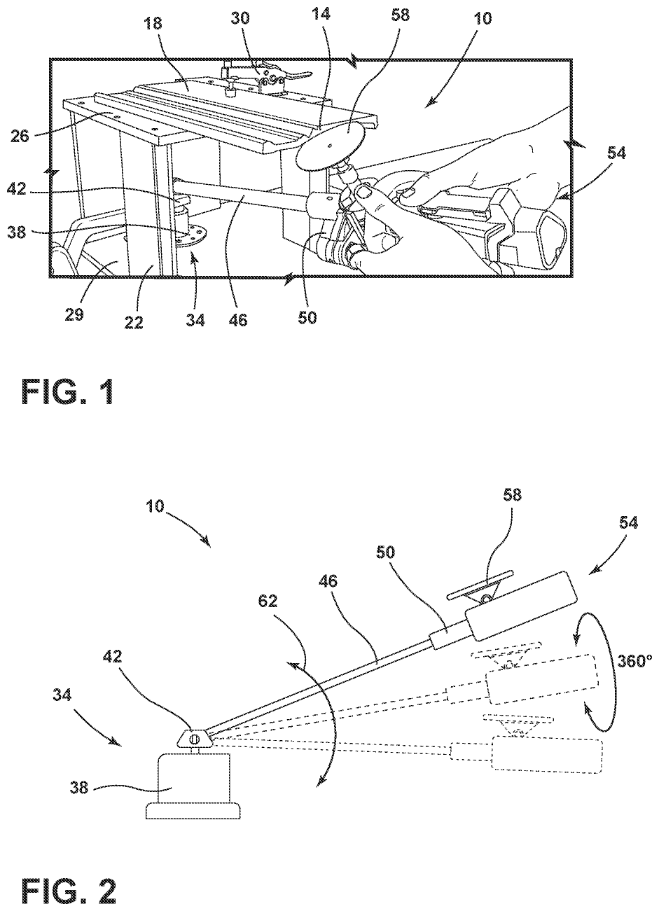

FIG. 1 illustrates a coping system 10 for making a coping cut 14 on a workpiece 18 (e.g., a baseboard, trim, crown molding, etc.). The coping system 10 includes a frame 22 having a table 26 for retaining the workpiece 18 via a clamp 30 and a base 29 to which a pivot mechanism 34 is secured. As shown in FIGS. 1 and 2, the pivot mechanism 34 includes a base portion 38 affixed to the base 29, a swiveling portion 42 having a support rod 46 extending outward from the swiveling portion 42, and an attachment portion 50 to which a coping tool 54 (e.g., a die grinder, a sander, etc.) is attachable. The coping tool 54 rotatably drives a cutting attachment 58 (e.g., a sanding disc, router bit, etc.) for making the coping cut 14 on the workpiece 18.

With reference to FIG. 2, the pivot mechanism 34 constrains the coping tool 54 at a fixed distance (e.g., the length of the support rod 46) from the frame 22 such that the user can make the coping cut 14 on the workpiece 18 that is consistent. The coping system 10 allows the user to pivot the support rod 46—and ultimately the coping tool 54—about a pivot path 62, while preventing translational movement of the coping tool 54 along the length of the support rod 46. Furthermore, the attachment portion 50 of the pivot mechanism 34 allows the user to rotate the coping tool 54 by 360 degrees about the support rod 46 to allow the user to precisely maneuver the coping tool 54 relative to the workpiece 18. Put simply, the swiveling portion 42 of the illustrated embodiment, is a ball joint that allows unrestricted pivoting and rotation of the support rod 46 relative to the base portion 38. In some embodiments, the coping tool 54 can translate along the support rod 46 toward or away from the pivot mechanism 34 (e.g., via a telescoping mechanism, a slide mechanism, etc.), such that the coping tool 54 is not at a fixed distance away from the pivot mechanism 34.

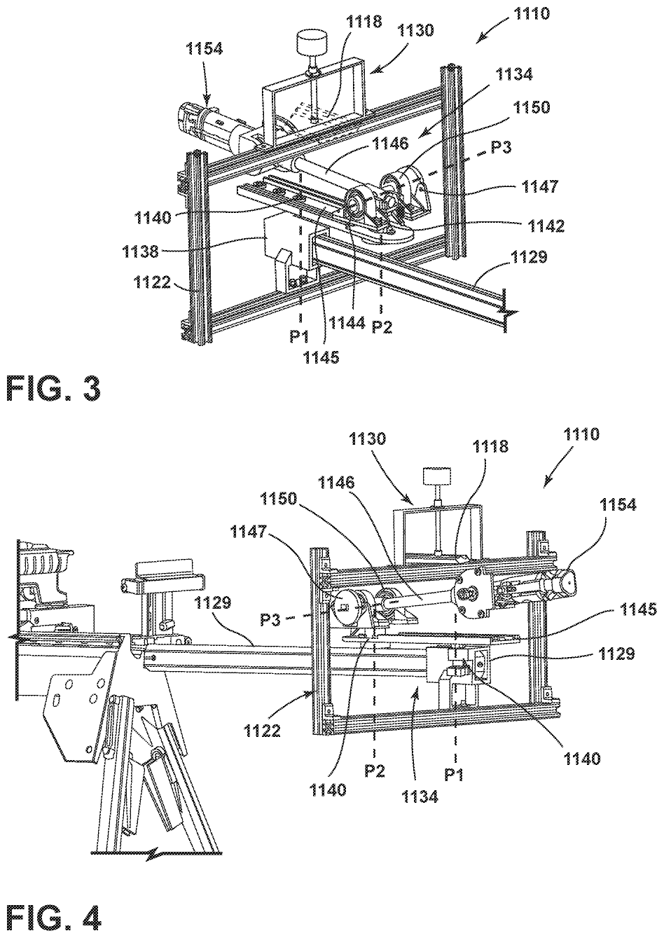

FIGS. 3-5B illustrate an alternative embodiment of a coping system 1110 similar to that of FIGS. 1-2, with differences described below. While the coping system 10 includes the pivot mechanism 34 that is a ball joint, the coping system 1110 includes a pivot mechanism 1134 that consists of multiple pivot joints, some of which are spring assisted to support the weight of tool. Like components and features as the coping system 10 of FIG. 1 will be used plus “1100”.

With reference to FIGS. 3 and 4, the illustrated embodiment of the coping system 1110 includes a frame 1122 coupled to an equipment stand 1129 (e.g., saw stands, work tables, etc.) and a coping tool 1154 movably supported relative to the frame 1122. The frame 1122 is an adjustable frame, such that the width and height of the frame 1122 may be changed to accommodate various workpieces 1118 relative to the equipment stand 1129. The frame 1122 includes a clamp 1130 that is disposed above the equipment stand 1129 and the coping tool 1154. The clamp 1130 is configured to securely hold a workpiece 1118 relative to the frame 1122 during the coping operation. The coping system 1110 further includes the pivot mechanism 1134 having a base portion 1138, a first pivot joint 1140 defining a first pivot axis P1, a second pivot joint 1142 defining a second pivot axis P2, and a third pivot joint 1144 defining a third pivot axis P3. The base portion 1138 couples the frame 1122 to the equipment stand 1129. The first pivot joint 1140 is coupled to the second pivot joint 1142 via an elongated plate 1145, and the second pivot joint 1142 is coupled to the third pivot joint 1144 via a bracket 1147. The first pivot axis P1 is parallel to the second pivot axis P2, whereas the third pivot axis P3 is perpendicular to the first and second pivot axes P1, P2. A support rod 1146 couples the coping tool 1154 to the pivot mechanism 1134.

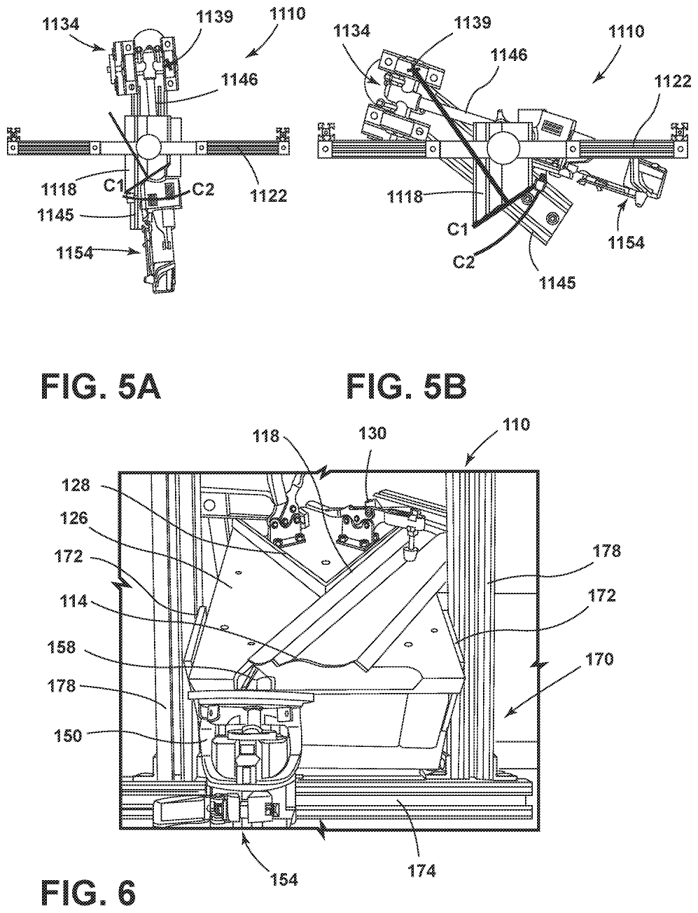

Some advantages of the pivot mechanism 1134 include enabling a user to position the coping tool 1154 to be substantially perpendicular to a coping path C1 (FIGS. 5A and 5B), so the user can make a proper coping cut 1114. This is accomplished by moving the aggregated center of rotation 1139 of pivot axes P2 and P3 in three-dimensional space via the joints 1140, 1142, 1144 so the center of rotation 1139 is perpendicular to the coping path C1, as shown in FIG. 5B. Also, the pivot mechanism 1134 enables a tool path C2 of the coping tool 1154 to more closely follow the coping path C1 due to the multitude of degrees of freedom.

With continued reference to FIGS. 3 and 4, the third pivot joint 1144 includes a spring-damper system 1150 to offset a weight of the coping tool 1154 from the user, which in turn reduces the user's fatigue over time. That said, the spring-damper system 1150 biases the coping tool 1154 upward toward the workpiece 1118. Additionally, the spring-damper system 1150 dampens the motion of the coping tool 1154 to allow for more precise cuts. In other words, the spring-damper system 1150 slightly resists or slows movement of the coping tool 1154 as the user attempts to move the coping tool 1154 relative to the workpiece 1118.

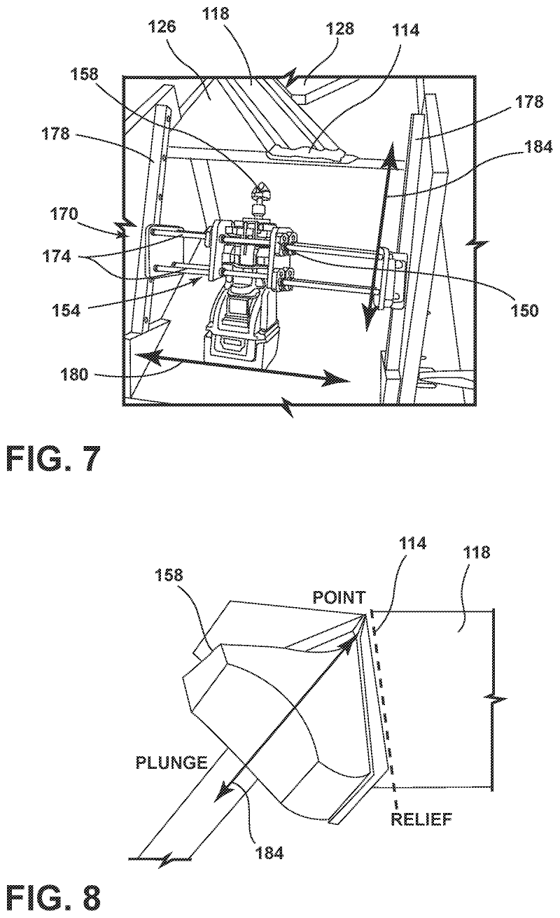

FIGS. 6-8 illustrate a coping system 110 according to an alternative embodiment. Like components and features as the coping system 10 of FIG. 1 will be used plus “100”. The coping system 110 includes a table 126 having a guide 128 for guiding a workpiece 118 (e.g., a baseboard) and a clamp 130 for restraining the workpiece 118 on the table 126 so the user can make a precise coping cut 14 on the workpiece 118. The coping system 110 further includes a gantry 170 mounted to the table 126 via a plurality of mounting brackets 172 disposed on opposite sides of the table 126 and a coping tool 154 (e.g., a router, jigsaw, etc.) having a cutting attachment 158 mounted to the gantry 170 via an attachment portion 150. The illustrated cutting attachment 158 is a router bit, while in other embodiments, the cutting attachment 158 may be a drill bit, a fluted drill bit, or a cutting blade, as described in further detail below. The gantry 170 includes one or more horizontal members 174 extending along a coping axis 180 (FIG. 7) and a plurality of vertical members 178 obliquely oriented relative to the one or more horizontal members 174 extending along a plunge axis 184. The coping tool 154 can be slidably received on the horizontal members 174 of the gantry 170 via the attachment portion 150 such that the user can translate the coping tool 154 along the coping axis 180 relative to the workpiece 118.

In addition to translating the coping tool 154 along the coping axis 180, the user can also adjust a plunge depth of the cutting attachment 158 by sliding the coping tool 154 along the plunge axis 184 (FIG. 6) relative to the workpiece 118 for fine tuning the coping cut 114. The plunge depth can be adjusted by sliding the coping tool 154 along the vertical members 178 toward or away from the workpiece 118 according to the user selected plunge depth. By constraining the translational movement of the coping tool 154 and the cutting attachment 158 along the coping axis 180, the user can minimize fatigue from moving the coping tool 154 in more than one plane, while simultaneously minimizing the number of macro-adjustments to the plunge depth along the plunge axis 184 and angle of the cutting attachment 158, thereby yielding a more consistent and precise coping cut 114. As such, the coping tool 154 can be maneuvered along the horizontal members 174 and the vertical members 178 simultaneously, allowing the user to make the precise coping cut 114 along the workpiece 118 via the cutting attachment 158.

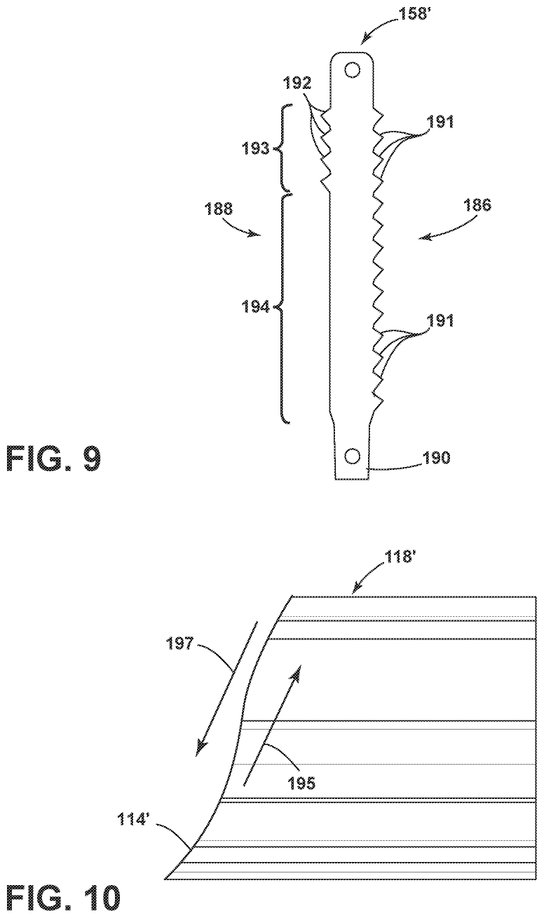

As shown in FIG. 9, the cutting attachment 158 may alternatively be a cutting blade 158′ used in the coping tool 154. The cutting blade 158′ is driven by the coping tool 154 in a reciprocating manner to make a coping cut 114′ in the workpiece 118′. The cutting blade 158′ has a first side 186, a second side 188, and an attachment portion 190. The first side 186 of the cutting blade 158′ includes a first plurality of teeth 191 extending along the first side 186. The second side 188 of the cutting blade 158′ includes a cutting portion 193 including a second plurality of teeth 192 and a flat portion 194 without any teeth. The first plurality of teeth 191 may have a different pitch and direction than the second plurality of teeth 192. During a coping cut 114′, the user maneuvers the coping tool 154 along a first direction 195 through the workpiece 118 (FIG. 10), such that the first plurality of teeth 191 of the first side 186 engage the workpiece 118 to make the coping cut 114′. Depending on the geometry of a coping cut 114′, the user may need move the cutting blade 158′ in a second direction 197 that is, for example, opposite to the first direction 195. When moving in the second direction 197, the user may use the cutting portion 193 or the flat portion 194 of the second side 188. If the cutting portion 193 is engages the workpiece 118′, the cutting blade 158′ removes material in the second direction 197 changing the geometry of the coping cut 114′. If the flat portion 194 is used, the cutting blade 158′ is inhibited from removing material in the second direction 197 to maintain the existing geometry of the coping cut 114′.

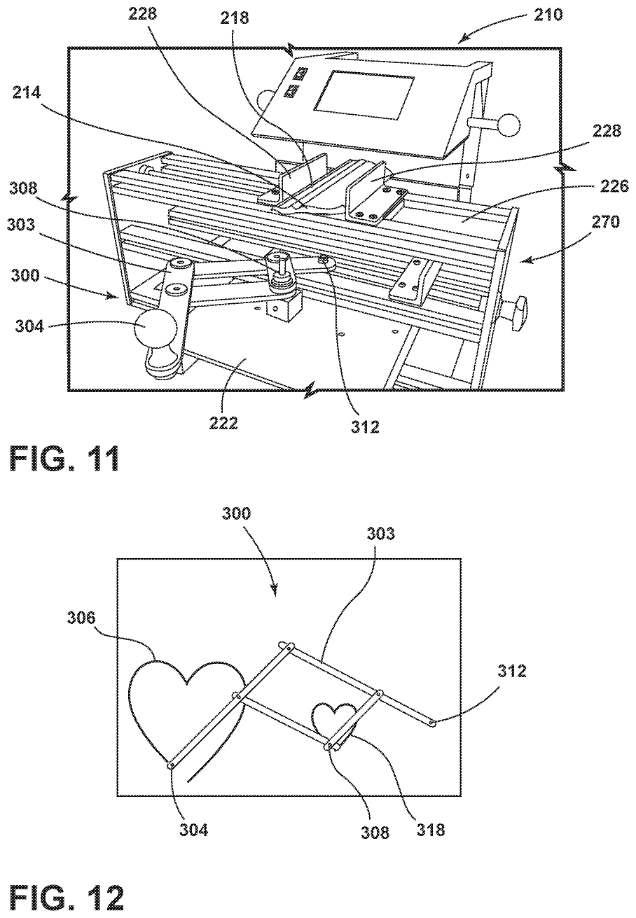

FIGS. 11-12 illustrate a coping system 210 according to an alternative embodiment. Like components and features as the coping system of FIG. 1 will be used plus “200”. The coping system 210 includes a gantry 270 for supporting a frame 222 having a table 226 with a plurality of guides 228 for guiding a workpiece 218 (e.g., a baseboard) into position for the user to make a coping cut 214. The coping system 210 further includes a linkage 300 for positioning a coping tool (e.g., a saw having a saw blade; not shown) relative to the workpiece 218 for making the coping cut 214. The linkage 300 includes a plurality of links 303 having a user input 304 configured as a joystick, an output pivot point 308 fastened to a saw sled (not shown) configured to maneuver the coping tool and saw blade relative to the workpiece 218 in response to movement from the user input 304, and a fixed pivot point 312 fastened to the gantry 270.

With respect to FIG. 11, the linkage 300 is configured as a pantograph. A pantograph typically includes a mechanical linkage that relies on input from a user that tracks a user's input in an input pathway and produces an identical scaled copy of the input pathway in a scaled output pathway on a secondary output side. In the case of the coping system 310, the user applies a force onto the user input 304 along an input pathway 306, which pivots the links 303 about the fixed pivot point 312 on the gantry 270 and traces a scaled version of the input pathway 306 into an output pathway 318 via the output pivot point 308. The output pivot point 308 directly moves the saw sled and subsequently the saw blade relative to the workpiece 218 according to the output pathway 318 in response to movement from the user input 304. In some embodiments, the scaling factor from the input pathway 306 relative to the output pathway 318 can be a factor of 3:1.

By configuring the linkage 300 as a pantograph, the linkage 300 improves the user's control of the coping tool by scaling down the intricate movement required for coping. In particular, the user is able to move the user input 304 three times the distance that the saw blade would actually travel. For example, a user has 3/16 of an inch of distance to move the user input 304 for a 1/16 of an inch movement on the output pivot point 308 and subsequent cut on the workpiece 218. The additional distance on the user input 304 of the linkage 300 allows for more precision on the output pivot point 308, thereby generate the coping cut 214 with precision and accuracy. Additionally, the pantograph linkage 300 decreases the amount of force that the user needs to apply to the saw sled to overcome static friction. Specifically, the amount of force is decreased by the scaling factor (e.g., 3:1) of the linkage 300. For example, in the coping system 210, 1.5 pounds of force that a user applies to the user input 304 is reduced by a factor of 3:1, which translates into 0.5 pounds of force being applied to the saw sled. This is advantageous because overcoming static friction to move the saw sled can cause the sled to jerk to one side, which can damage the workpiece 218 and prevent it from being properly joined together with adjacent workpieces 218.

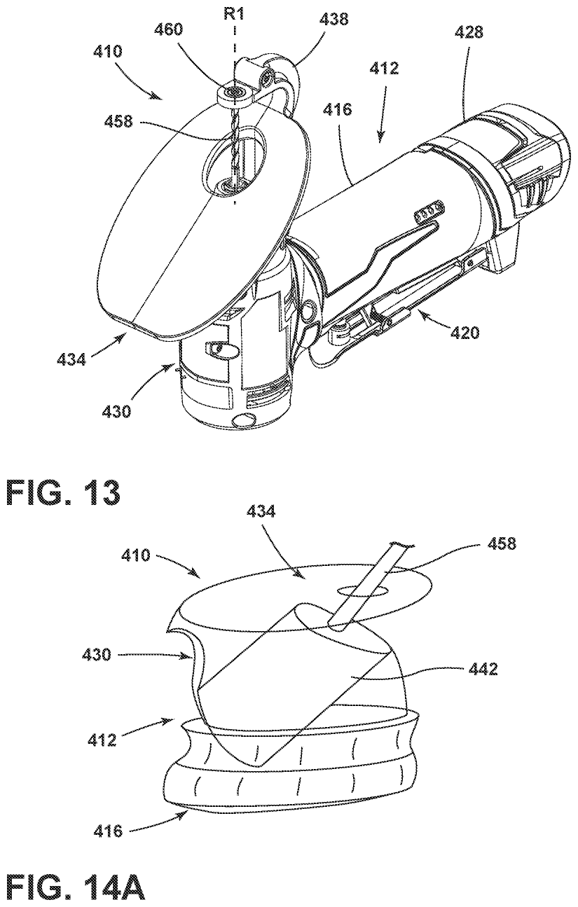

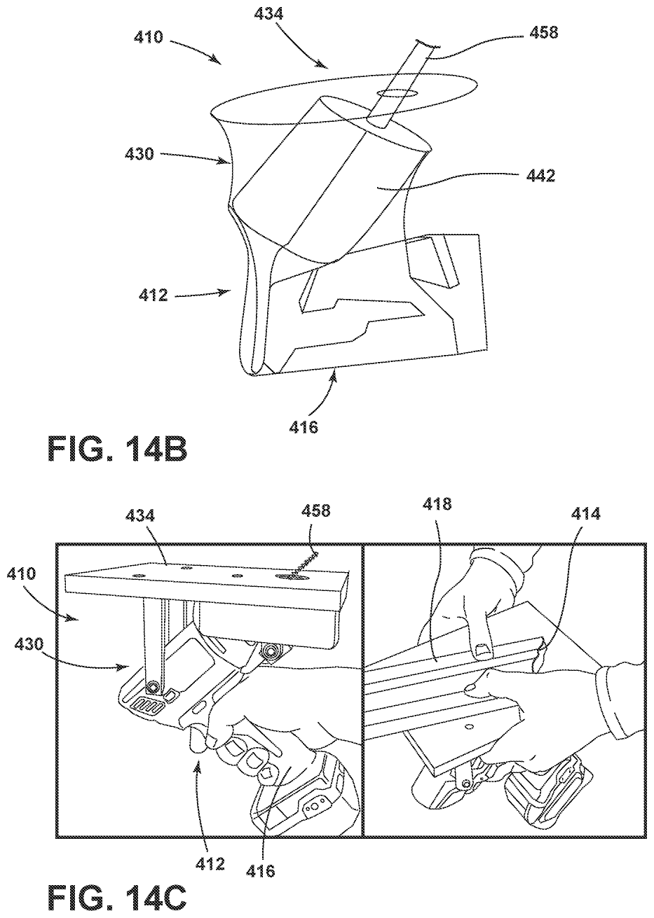

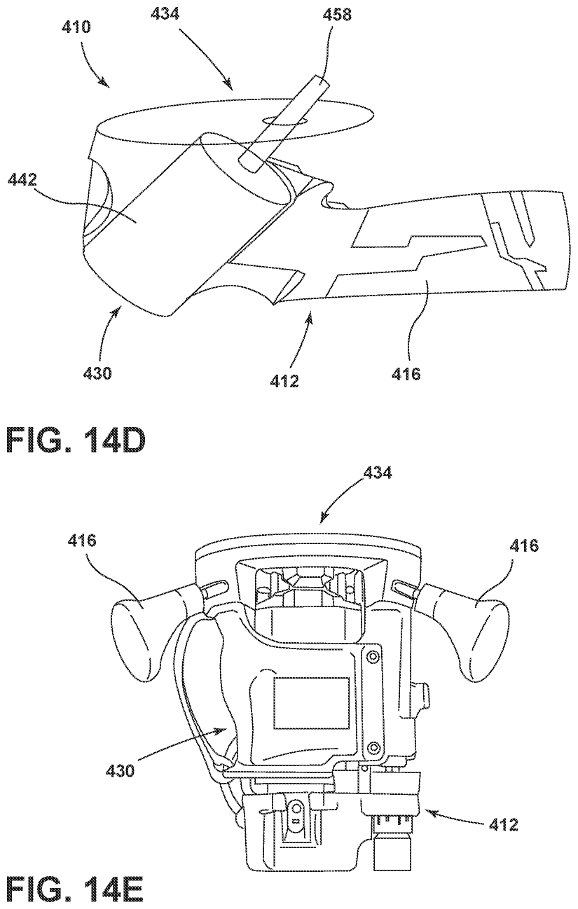

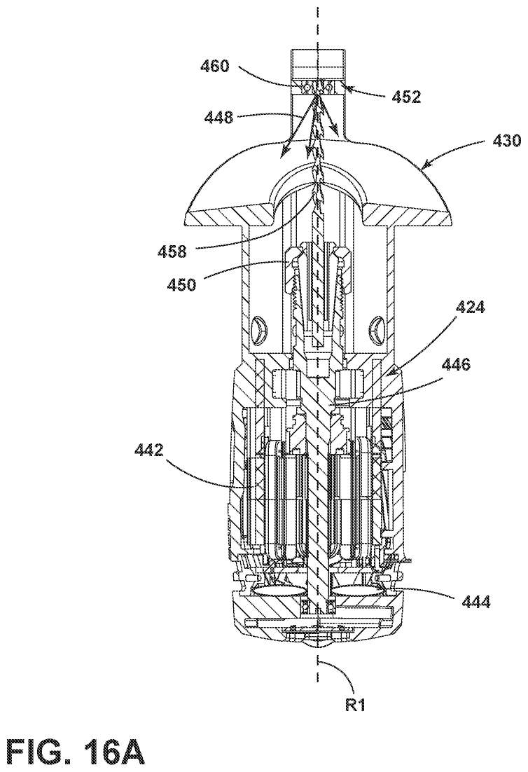

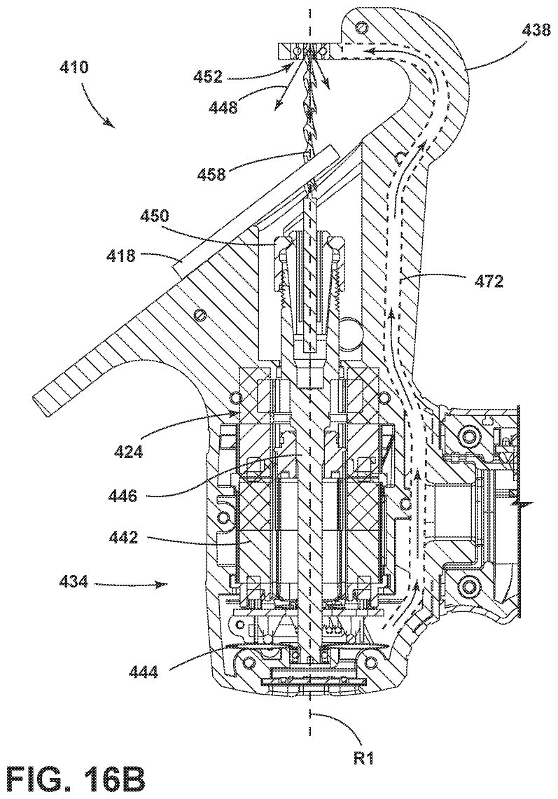

FIGS. 13-18 illustrate a coping tool 410 according to an alternative embodiment. As shown in FIG. 13, the coping tool 410 includes a main housing 412 defining a handle 416, and a trigger assembly 420 disposed on the handle 416. In the illustrated embodiment, the handle 416 is configured as a barrel-grip style handle, while in other embodiments, the handle 416 may alternatively be a palm-sander style handle (FIG. 14A), a compact or low style handle (FIG. 14B), a pistol-grip style handle (FIG. 14C), an obliquely angled handle (FIG. 14D), a wing style handle (FIG. 14E), or other style of handle. The trigger assembly 420 allows a user to control the speed of a drive mechanism 424 (FIG. 16) by varying the degree to which the trigger assembly 420 is actuated. The coping tool 410 further includes a rechargeable battery pack 428 that supplies power to the drive mechanism 424 (FIG. 13). In the illustrated embodiments, the drive mechanism 424 is a rotary drive mechanism. In other embodiments, the drive mechanism 424 may alternatively be a reciprocating drive mechanism. The battery pack 428 may include any of a number of different nominal voltages (e.g., 12V, 18V, etc.), and may be configured having any of a number of different chemistries (e.g., lithium-ion, nickel-cadmium, etc.). In alternative embodiments (not shown), the drive mechanism 424 may be powered by a remote power source (e.g., a household electrical outlet) through a power cord. The main housing 412 further houses control electronics (e.g., a PCBA, a micro switch, etc.).

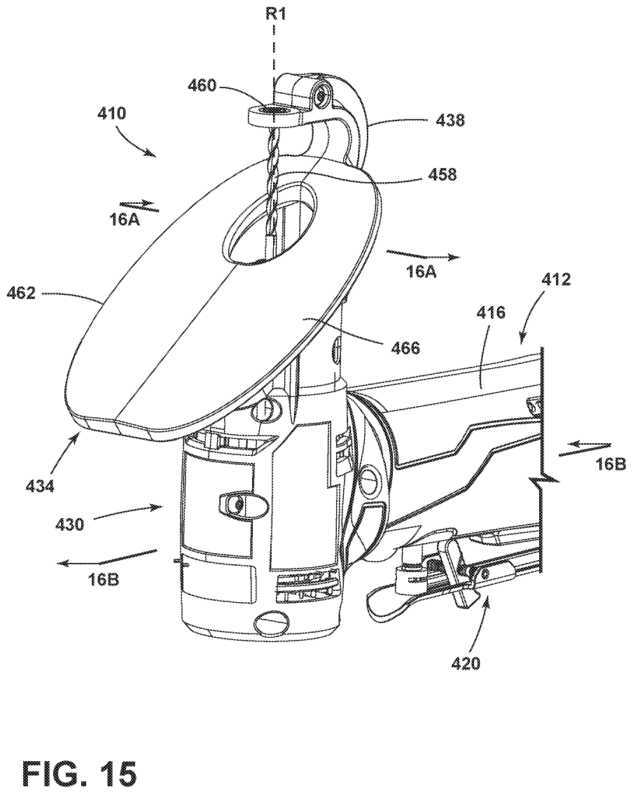

With reference to FIGS. 15 and 16A-B, the coping tool 410 further includes a motor housing 430 that is coupled to the main housing 412. The motor housing 430 houses the drive mechanism 424 and includes a shoe 434 against which a workpiece is slidable and a support arm 438 extending from the shoe 434. The drive mechanism 424, shown in FIGS. 16A-B, includes a motor 442 (e.g., an outer rotor BLDC motor, an inner rotor BLDC motor, etc.), a motor shaft 446 driven by the motor 442, a fan 444 disposed on the motor shaft 446, a tool chuck 450 disposed at a distal end of the motor shaft 446, and a cutting attachment 458 (e.g., a mill bit, a drill bit, a router bit, etc.) removably coupled to the tool chuck 450. The motor 442, the motor shaft 446, and the cutting attachment 458 are all coaxially aligned along the rotation axis R1. In the illustrated embodiment, the cutting attachment 458 is a mill bit able to remove material in a plane perpendicular to its rotation axis R1. The fan 444 is configured to rotate with the motor shaft 446 and generates airflow 448 as the motor 442 rotates. The shoe 434 includes an airflow channel 472 to direct the airflow 448 generated by the fan 470 to an outlet 452. The airflow channel 472 extends from a rear of the shoe 434 through the support arm 438, as shown in FIG. 16B. The outlet 452 is positioned in line with the rotational axis R1 and directs the airflow 448 onto the workpiece 418. The airflow 448 disperses dust and debris generated during the coping operation and provides the user with a clear view of the workpiece 418.

With continued reference to FIGS. 15 and 16A-B, the cutting attachment 458 is coupled to the tool chuck 450 at one end, while the other end of the cutting attachment 458 is rotatably supported by the support arm 438 via a ball bearing 460. The ball bearing 460 inhibits the cutting attachment 458 from deviating from the rotation axis R1 when a force is applied perpendicular to the cutting attachment 458. In other words, during a cutting operation, a workpiece 418 applies a force to the cutting attachment 458 that is perpendicular to the rotation axis R1 and the support arm 438 maintains alignment of the cutting attachment 458 with the rotation axis R1, thereby reducing tool bit chatter and improving the coping cut 414 (FIG. 14C). Furthermore, the support arm 438 protects the user from inadvertently contacting a distal end or a side of the cutting attachment 458. In other embodiments, the cutting attachment 458 may be the cutting blade 158′ driven in a reciprocating manner.

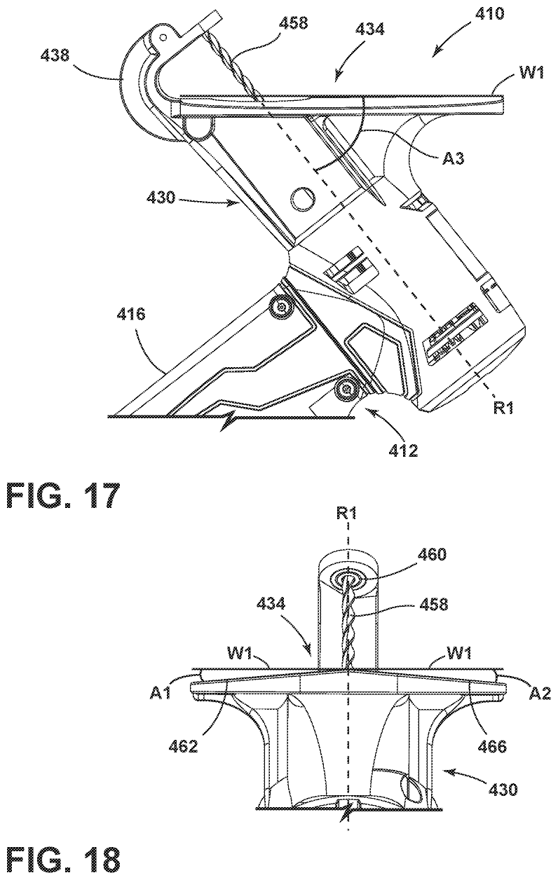

As shown in FIGS. 17 and 18, the shoe 434 includes a first support surface 462 and a second support surface 466. In the illustrated embodiment, the first support surface 462 and the second support surface 466 are angled relative to each other, such that the shoe 434 is not a continuously flat surface (although in some embodiments it may be). Specifically, the first support surface 462 and the second support surface 466 are both angled downward relative to a horizontal reference plane W1. That said, the first support surface 462 forms a first angle A1 relative to the plane W1 and the second support surface 466 forms a second angle A2 relative to the plane W1. In the illustrated embodiment, the first angle A1 and the second angle A2 are both 5 degrees, while in other embodiments, the first angle A1 and the second angle A2 may have other equal or unequal values. Still, in other embodiments, the first support surface 462 and the second support surface 466 may be pivotable relative to the plane W1, such that the first angle A1 and the second angle A2 are adjustable, for example, through a detent mechanism, a slide mechanism, or other similar mechanism. As such, the first support surface 462 and the second support surface 466 may be movable or pivotable to infinitely or discretely adjust the first angle A1 and the second angle A2 relative to the plane W1.

With continued reference to FIGS. 17 and 18, the shoe 434 is fixed relative to the rotation axis R1 of the cutting attachment 458. In other embodiments, the shoe 434 may alternatively pivot to change an angle A3 with respect to rotation axis R1 (FIG. 17). The angle A3 could be varied via a detent mechanism or other similar mechanism to move between preset values such as 90 degrees, 52 degrees, 45 degrees, or 38 degrees. In other embodiments, the shoe 434 may be adjustable to an infinite number of positions to change the angle A3 relative to the rotation axis R1.

During operation, the workpiece 418 can be supported by either the first support surface 462 or the second support surface 466 to make the preferred coping cut 414 along an end of the workpiece 418 so the workpiece 418 can appropriately abut against an adjacent workpiece 418. The user may subsequently perform a cut along a length of the workpiece 418 so the workpiece 418 can appropriately abut against a wall or ceiling. Of course, one advantage of the coping system 10 is that the coping cut 414 removes bulk material from the workpiece 418, whereas grinding the workpiece 418 requires multiple passes along the workpiece 418 and generates more dust and debris. As such, the coping tool 410 saves the user time.

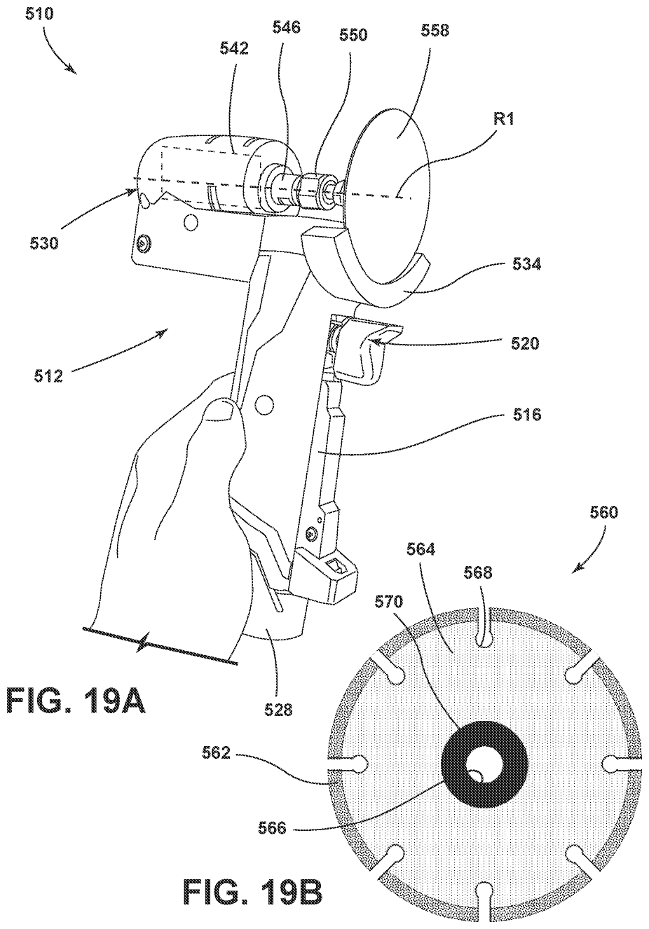

FIG. 19A illustrates a coping tool 510 according to an alternative embodiment. As shown in FIG. 19A, the coping tool 510 includes a main housing 512 defining a handle 516, a trigger assembly 520 disposed on the handle 516, and a motor housing 530 coupled to the main housing 512. The trigger assembly 520 allows a user to control the speed of a motor 542 (e.g., an outer rotor BLDC motor, an inner rotor BLDC motor, etc.) by varying the degree to which the trigger assembly 520 is actuated. The coping tool 510 further includes a rechargeable battery pack 528 that supplies power to the motor 542. The battery pack 528 may include any of a number of different nominal voltages (e.g., 12V, 18V, etc.), and may be configured having any of a number of different chemistries (e.g., lithium-ion, nickel-cadmium, etc.). The main housing 512 further houses control electronics (e.g., a PCBA, a micro switch, etc.) that control the operation of the motor 542.

Some advantages of employing an outer rotor BLDC motor is that outer rotor motors provide the required (in some cases increased) speed and torque output with a smaller footprint compared to inner rotor BLDC motors. For example, an outer rotor BLDC motor may provide 4,000 surface feet per minute at 1.5 inch-pounds of torque. This speed is achievable when a cutting attachment 558 is employed having a diameter of three inches. Also, outer rotor motors tend to be shorter in length than a traditional inner rotor motor.

With continued reference to FIG. 19A, a motor shaft 546 is driven by the motor 542 and includes a tool chuck 550 disposed at a distal end of the motor shaft 546. The cutting attachment 558 (e.g., a sanding disc, router bit, etc.) is removably coupled to the tool chuck 550. In the illustrated embodiment, the cutting attachment 558 is a sanding disc able to remove material in a plane perpendicular to its rotation axis R1. The motor 542, the motor shaft 546, and the cutting attachment 558 are all coaxially aligned along the rotation axis R1. The coping tool 510 further includes a shoe 534 upon which a workpiece is supportable. Specifically, a workpiece may rest against the shoe 534 during a cutting operating. The shoe 534 extends from the main housing 512 and is disposed adjacent at least a portion of the outer periphery of the cutting attachment 558. The shoe 534 is also disposed between the trigger assembly 520 and the cutting attachment 558, and protects a user from inadvertently contacting the cutting attachment 558. In this arrangement, the cutting attachment 558 is advantageously positioned proximate the handle 516 and the trigger assembly 520, which increases control of the coping tool 510 relative to a workpiece.

FIG. 19B illustrates a cutting attachment 560 in accordance with another embodiment of the invention. The cutting attachment 560 is a sanding disc similar to the cutting attachment 558 but also includes a cutting edge 562. Specifically, the cutting edge 562 is disposed at an outer periphery of the cutting attachment 560, while an abrasive region 564 is disposed radially inward from the cutting edge 562 and extends to an aperture 566. In other words, the abrasive region 564 is disposed radially outward from the aperture 566 and the cutting edge 562 is disposed radially outward from the abrasive region 564 to the outer periphery of the cutting attachment 560. Both faces of the cutting attachment 560 are identical, such that each face includes the cutting edge 562 and the abrasive region 564. This allows a user to use both faces of the cutting attachment 560 during a coping operation with minimal maneuvering of the coping tool 510. A plurality of cutouts 568 are disposed along the outer periphery of the cutting attachment 560 to facilitate cutting a workpiece and cooling to the cutting edge 562. The aperture 566 may receive the tool chuck 550 and a fastener can thread onto the tool chuck 550 to clamp the cutting attachment 560 to the tool chuck 550 for rotation therewith. The fastener clamps down on a bearing region 570 adjacent the aperture 566. The cutting edge 562 is composed of a first material and the abrasive region 564 is composed of a second material. In some embodiments, the first material is stronger and harder than the second material, while in other embodiments, the first material and the second material are the same. In some embodiments, the first material is carbide and the second material is an abrasive grain (e.g., aluminum oxide grain, etc.). Still, in some embodiments, the abrasive region 564 may be a replaceable adhesive-backed sanding disc having the abrasive grain, such that the sanding disc may be removed when worn out and replaced with a new sanding disc. The abrasive region 564 may have varying grits. Still yet, in some embodiments, the abrasive region 562 may have greater grit on one face and less grit on the opposite face.

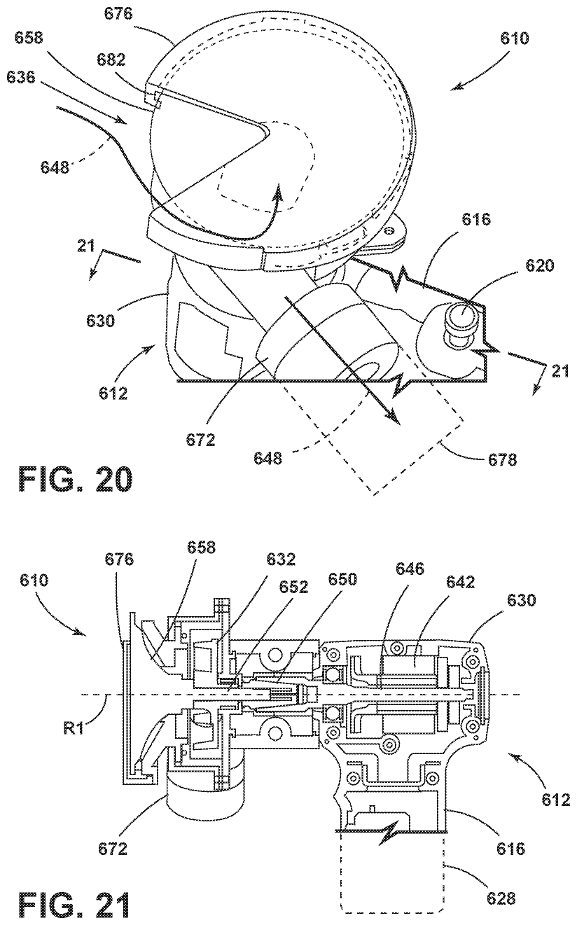

FIGS. 20-23 illustrate a coping tool 610 according to an alternative embodiment. As shown in FIG. 20, the coping tool 610 includes a main housing 612 defining a handle 616, a trigger assembly 620 disposed on the handle 616, and a motor housing 630 coupled to the main housing 612. The trigger assembly 620 allows a user to control the speed of a motor 642 (e.g., an outer rotor BLDC motor, as shown in FIGS. 21 and 23) by varying the degree to which the trigger assembly 620 is actuated. The coping tool 610 further includes a rechargeable battery pack 628 that supplies power to the motor 642. The battery pack 628 may include any of a number of different nominal voltages (e.g., 12V, 18V, etc.), and may be configured having any of a number of different chemistries (e.g., lithium-ion, nickel-cadmium, etc.). The main housing 612 further houses control electronics (e.g., a PCBA, a micro switch, etc.) that control the operation of the motor 642.

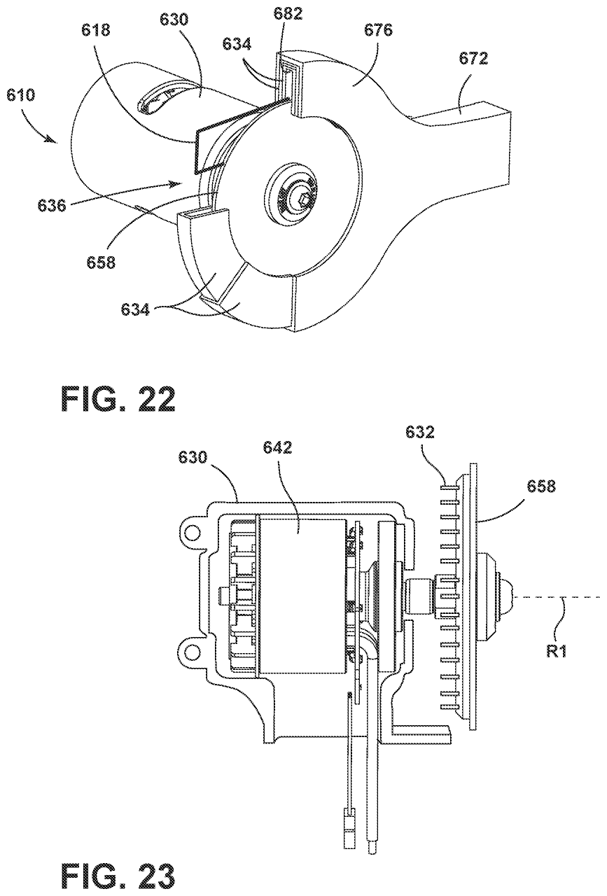

With continued reference to FIGS. 20-23, a motor shaft 646 is driven by the motor 642 and includes a tool chuck 650 disposed at a distal end of the motor shaft 646. A cutting attachment 658 (e.g., a sanding disc, router bit, etc.) is removably coupled to the tool chuck 650. In the illustrated embodiment, the cutting attachment 658 is a sanding disc able to remove material in a plane perpendicular to its rotation axis R1. The coping tool 610 may alternatively receive the cutting attachment 560 (FIG. 19B). The motor 642, the motor shaft 646, and the cutting attachment 658 are all coaxially aligned along the rotation axis R1. The coping tool 610 further includes a fan 632 for generating an airflow 648 and a dust shroud 676 disposed at least partially around the cutting attachment 658. The fan 632 is disposed within the main housing 612 behind the cutting attachment 658, such that the fan 632 is disposed between the cutting attachment 658 and the motor 642. In some embodiments, the fan 632 is coupled directly to the motor shaft 646 or to a spindle 652 of the cutting attachment 658 (FIG. 21), while in other embodiments, the fan 632 is alternatively integrated with or coupled directly to the cutting attachment 658 (FIG. 23). The dust shroud 676 at least partially protects a user from inadvertently contacting the cutting attachment 658. The dust shroud 676 includes a channel 682 (FIGS. 20 and 22) disposed along the dust shroud 676 that receives and surrounds the outer periphery of the cutting attachment 658. In other words, the channel 682 is U-shaped to surround the outer periphery of the cutting attachment 658.

With continued reference to FIGS. 20-22, the airflow 648 created by the fan 632 draws dust and debris from the workpiece 618 into the dust shroud 676 during a cutting operation. The dust shroud 676 includes a cut zone opening 636 where the cutting attachment 658 is exposed. That is, a user may pass the workpiece 618 through the cut zone opening 636 and engage the cutting attachment 658 to perform a cutting operation. In the illustrated embodiment of FIG. 20, the cut zone opening 636 is fixed in size and shape. In other embodiments, the dust shroud 676 may include a series of arcuate segments 634 that may or may not be spring-loaded, allowing the cut zone opening 636 to change in size and accommodate different workpieces 618. Specifically, the series of arcuate segments 634 may be moveable between a first position, in which the cutting attachment 658 is substantially covered, and a second position, in which the cutting attachment 658 is at least partially exposed. The series of arcuate segments 634 is biased toward the first position. The series of arcuate segments 634 are telescopically connected together, such that an adjacent segments 634 nest within each other in the second position. The coping tool 610 further includes an outlet port 672 in fluid communication with the dust shroud 676 and is capable of directing dust and debris toward a vacuum source or a dust collector 678 (e.g., dust bag, dust box, etc.).

During operation, the trigger assembly 620 is depressed to activate the motor 642, thereby driving the motor shaft 646, the fan 632, and the cutting attachment 658. As a result, the airflow 648 causes ambient air to flow through the dust shroud 676, the fan 632, the outlet port 672, and eventually the dust collector 678 or the vacuum source. By placing the workpiece 618 in contact with the cutting attachment 658, dust and debris are generated and directed along the airflow 648 where the dust and debris will be collected by the dust collector 678 or the vacuum source.

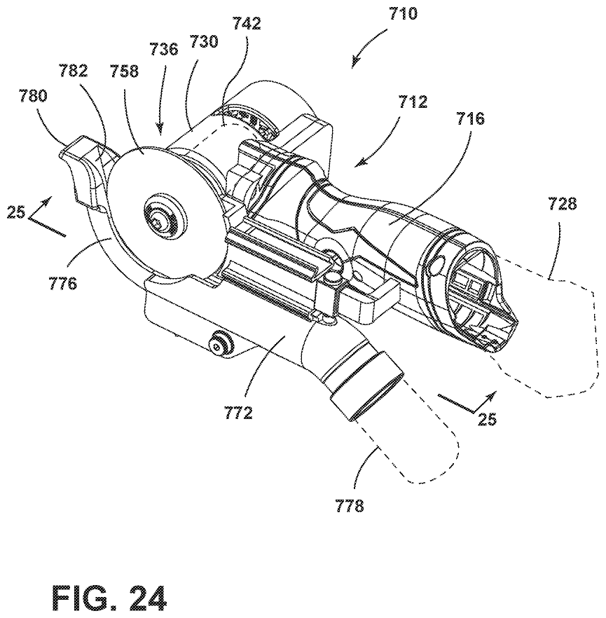

FIGS. 24-26 illustrate a coping tool 710 according to an alternative embodiment. As shown in FIG. 24, the coping tool 710 includes a main housing 712 defining a handle 716, a trigger assembly disposed on the handle 716, and a motor housing 730 coupled to the main housing 712. The trigger assembly allows a user to control the speed of a motor 742 (e.g., an outer rotor BLDC motor, as shown in FIG. 23) by varying the degree to which the trigger assembly is actuated. The coping tool 710 further includes a rechargeable battery pack 728 that supplies power to the motor 742. The battery pack 728 may include any of a number of different nominal voltages (e.g., 12V, 18V, etc.), and may be configured having any of a number of different chemistries (e.g., lithium-ion, nickel-cadmium, etc.). The main housing 712 further houses control electronics (e.g., a PCBA, a micro switch, etc.) that control the operation of the motor 742.

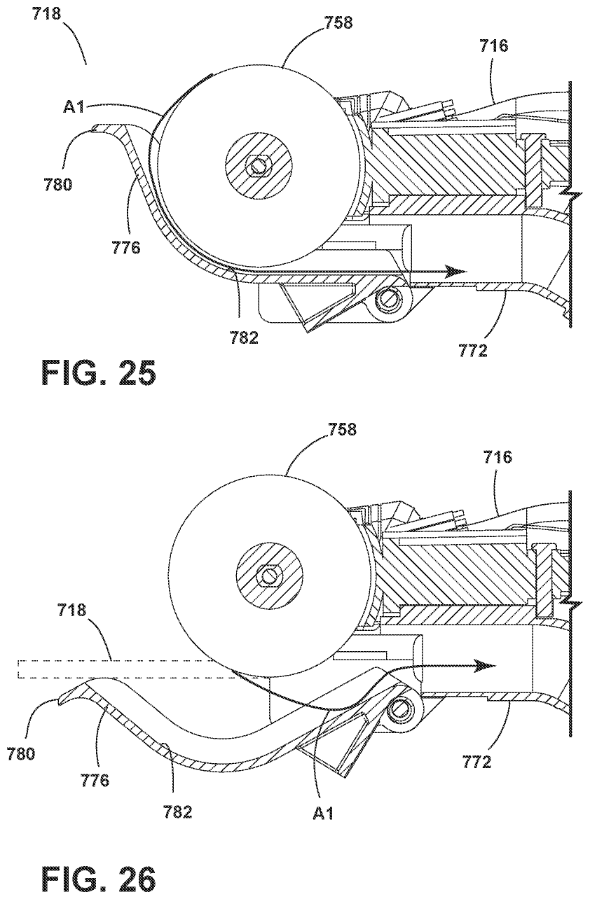

With reference to FIGS. 24-26, a cutting attachment 758 (e.g., a sanding disc, router bit, etc.) is removably coupled to the coping tool 710. In the illustrated embodiment, the cutting attachment 758 is a sanding disc able to remove material in a plane perpendicular to its rotation axis R1. The coping tool 710 may alternatively receive the cutting attachment 560 (FIG. 19B). The motor 742 and the cutting attachment 758 are coaxially aligned along the rotation axis R1. The coping tool 710 further includes a dust shroud 776 disposed at least partially around the cutting attachment 758. The dust shroud 776 at least partially protects a user from inadvertently contacting the cutting attachment 758. The dust shroud 776 is pivotably coupled to the main housing 712, such that the dust shroud 776 is moveable between a first position (FIG. 25), in which the dust shroud 776 is adjacent the cutting attachment 758, and a second position (FIG. 26), in which the dust shroud 776 is spaced away from the cutting attachment 758. An outlet port 772 is in fluid communication with the dust shroud 776 and is capable of directing dust and debris toward a vacuum source or a dust collector 778 (e.g., dust bag, dust box, etc.). The workpiece 718 may through a cut zone 736 and engage the cutting attachment 758 to perform a cutting operation. The cut zone 736 may change in size and shape to accommodate different workpieces 718 as the dust shroud 776 moves between the first position and second position. The dust shroud 776 further includes a rounded tip 780 and a channel 782 that extends along the dust shroud 676 adjacent the cutting attachment 758. When the workpiece 718 contacts the rounded tip 780, the dust shroud 776 is biased from the first position to the second position, as represented by FIG. 26. Also, the channel 782 receives the cutting attachment 758 when the dust shroud 776 is in the first position, such that such that the outer periphery of the cutting attachment 758 near the dust shroud 776 is surrounded by the channel 782. In other words, the channel 782 is U-shaped to surround the outer periphery of the cutting attachment 758.

During operation, the workpiece 718 is placed in contact with the cutting attachment 758 which generates dust and debris traveling with velocity in a direction tangential to the point of contact between the workpiece 718 and the cutting attachment 758, as represented by the arrow A1 in FIGS. 25 and 26. The channel 782 of the dust shroud 776 receives and redirects the dust and debris towards the outlet port 772. At this point, the dust and debris is passively collected in the dust collector 778. In other embodiments, the dust and debris may be alternatively collected by the dust collector 778 or the vacuum source by an induced airflow.

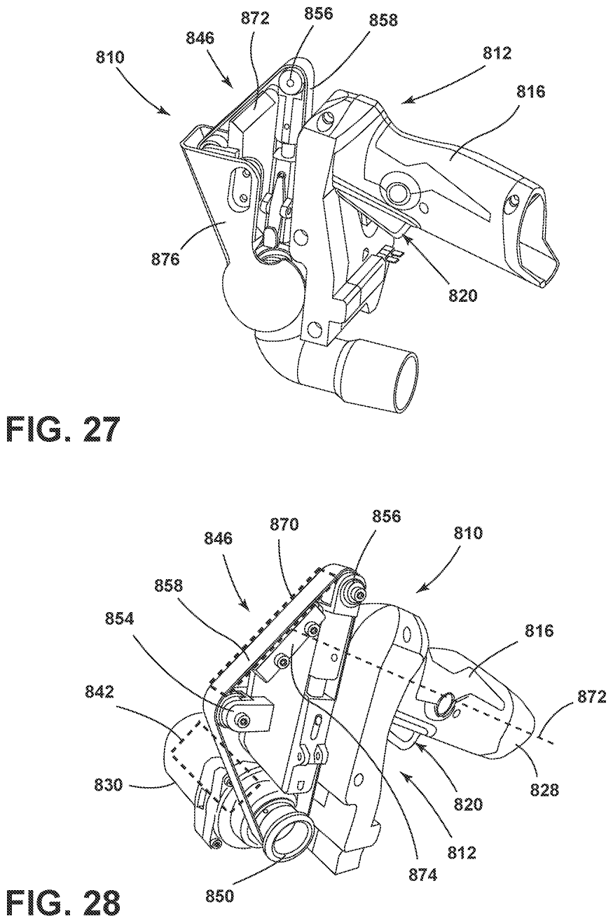

FIGS. 27-28 illustrates a coping tool 810 according to an alternative embodiment. As shown in FIGS. 27, the coping tool 810 includes a main housing 812 defining a handle 816, a trigger assembly 820 disposed on the handle 816, and a motor housing 830 (FIG. 28) coupled to the main housing 812. The trigger assembly 820 allows a user to control the speed of a motor 842 by varying the degree to which the trigger assembly 820 is actuated. The coping tool 810 further includes a rechargeable battery pack 828 (FIG. 28) that supplies power to the motor 842. The battery pack 828 may include any of a number of different nominal voltages (e.g., 12V, 18V, etc.), and may be configured having any of a number of different chemistries (e.g., lithium-ion, nickel-cadmium, etc.). The main housing 812 further houses control electronics (e.g., a PCBA, a micro switch, etc.) that control operation of the motor 842.

With continued reference to FIGS. 27-28, the motor 842 drives a belt assembly 846 that performs a cutting operation on a workpiece. The belt assembly 846 includes a drive wheel 850, a first driven wheel 854, a second driven wheel 856, and a sanding belt 858 wrapped around the wheels 850, 854, 856. The sanding belt 858 is removably coupled to the wheels 850, 854, 856. In the illustrated embodiment, an exposed portion of the sanding belt 858 between the first driven wheel 854 and the second driven wheel 856 defines a cutting area 870 (FIG. 28) able to remove material. The cutting area 870 is unobstructed and is advantageously proximate to the hand of a user, which increases control of the cutting area 870 relative to a workpiece. The cutting area 870 is also directly above and aligned with the handle 816, such that a longitudinal axis 872 of the handle 816 intersects the cutting area 870. A platen 874 is also disposed between the first driven wheel 854 and the second driven wheel 856 on the underneath side of the sanding belt 858 so the sanding belt 858 can be pressed against a workpiece without undue deformation and wear on the sanding belt 858. The remaining length of the sanding belt 858 is encased by the main housing 812 and a dust shroud 876 (FIG. 27). A vacuum source may be coupled to the dust shroud 876 to enable removal of dust and debris during a cutting operation.

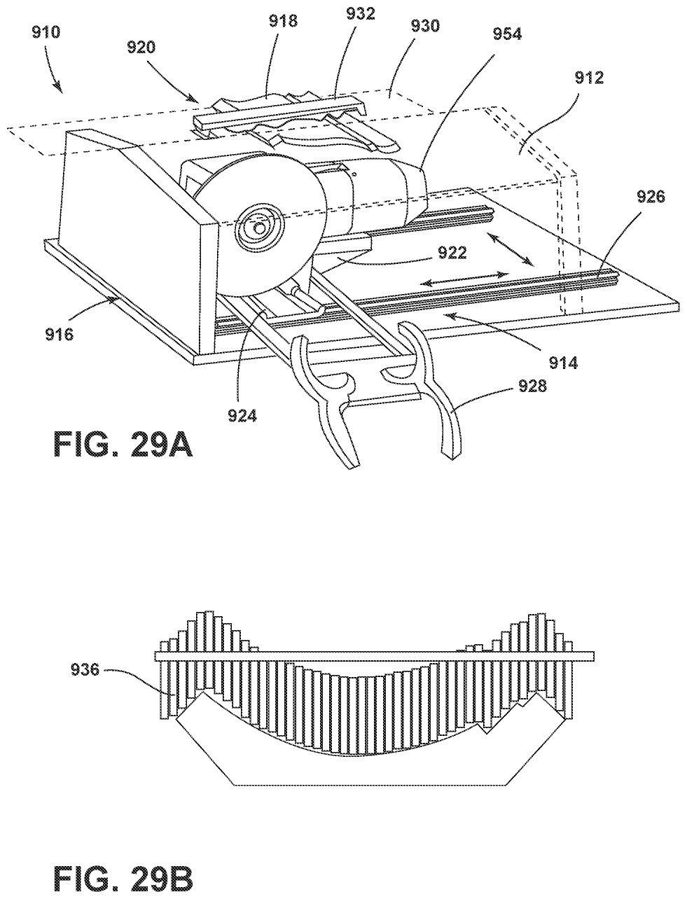

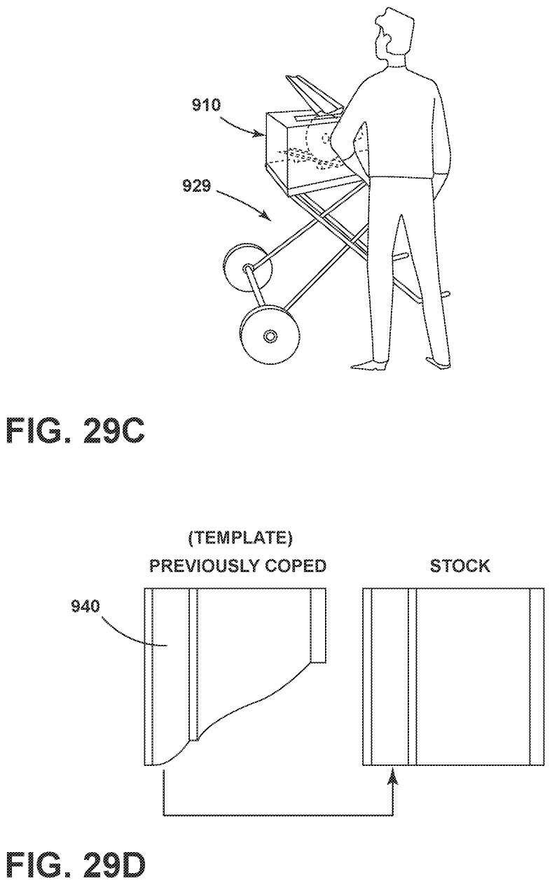

FIGS. 29A-29D illustrate a coping system 910 according to an alternative embodiment. Like components and features as the coping system 10 of FIG. 1 will be used plus “900”. FIG. 29A illustrates the coping system 910 including a protective screen 912, a gantry system 914, a debris collection system 916, and a clamp assembly 920. The gantry system 914 includes a coping tool 954, a tool carrier 922 for supporting the coping tool 954, a first sliding rail 924, a second sliding rail 926 arranged perpendicular to the first sliding rail 924, and a handle 928. The tool carrier 922 is slidably mounted on the first sliding rail 924, which is slidably mounted to the second sliding rail 926. The handle 928 is coupled to the tool carrier 922, which allows a user to move the tool carrier 922 along the first sliding rail 924 and the second sliding rail 926, thereby allowing the coping tool 954 to move in two dimensions within a plane. The coping system 910 may be supported atop an equipment stand 929, as shown in FIG. 29C. Additionally, the gantry system 914 includes a templating feature, where a coping cut of an adjacent workpiece (not shown) can be copied onto the workpiece 918 that is clamped in the clamp assembly 920, as described in further detail below.

With reference to FIG. 29A, the protective screen 912 is mounted between the coping tool 954 and the handle 928 and is meant to inhibit dust and debris from inadvertently exiting the coping system 910. The debris collection system 916 includes a vacuum system (not shown) and a debris collection bin (not shown). When the coping tool 954 is in operation, the vacuum system (not shown) is turned on simultaneously to collect the dust and debris during the coping operation. The dust and debris are deposited into the debris collection bin (not shown), which can then be removed to be emptied.

With continued reference to FIG. 29A, the clamp assembly 920 includes a bottom clamping surface 930 and a top clamping surface 932. The clamp assembly 920 clamps the workpiece 918 in position to avoid obstructing visibility of the workpiece 918. The coping system 910 further includes a roughing gauge 936 (FIG. 29B) and a templating guide 940 (FIG. 29D) that act as barriers for the coping tool 954, inhibiting movement of the coping tool 954 off the coping cut. The roughing gauge 936 approximates the contour of the workpiece and guides the coping tool 954 during the initial, bulk coping operation. The roughing gauge 936 can then be removed to allow for more precise coping cuts. The templating guide 940 is coupled to the gantry system 914 to help the user make repeated coping cuts with the coping tool 954.

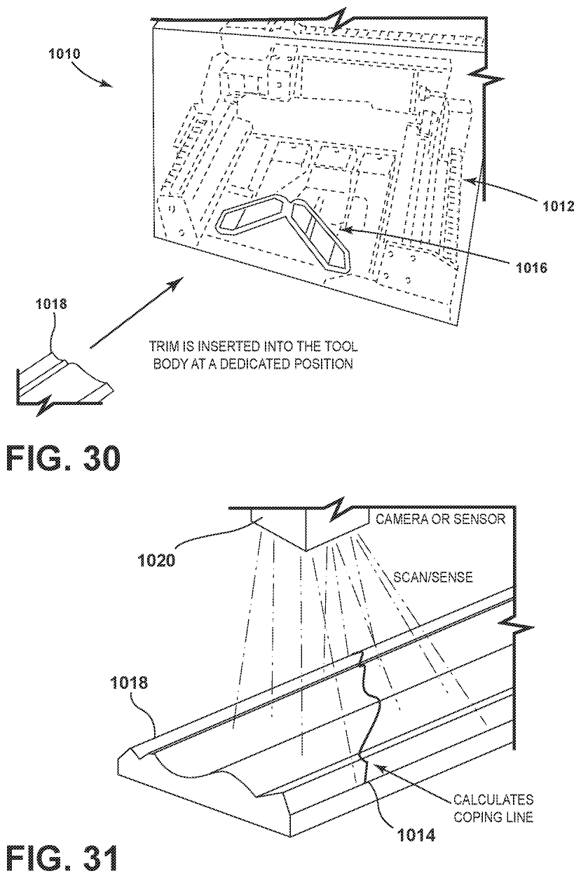

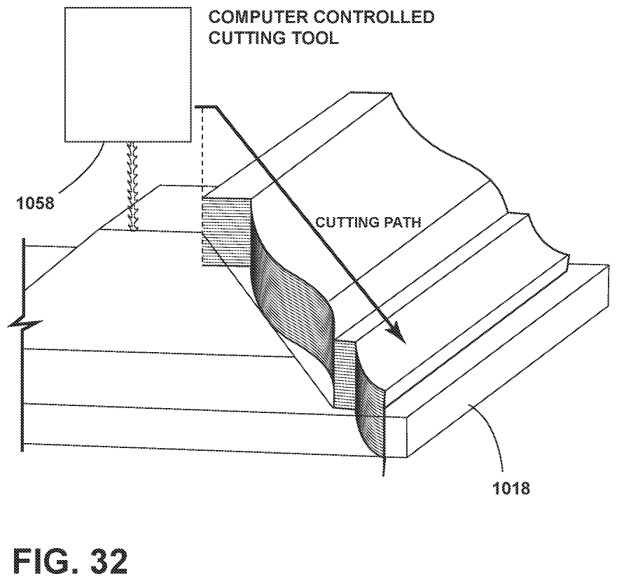

FIGS. 30-32 illustrate a coping system 1010 according to an alternative embodiment. Like components and features as the coping system 10 of FIG. 1 will be used plus “1000”. The coping system 1010 includes a tool body 1012, an opening 1016 disposed through the tool body 1012, and a cutting attachment 1058 disposed within the tool body 1012 (FIG. 32). The coping system 1010 further includes a controller and a sensor 1020 (e.g., camera, etc.; FIG. 31) disposed within the tool body 1012 that is configured to analyze a workpiece 1018 to perform an optimal coping cut 1014. The controller receives input signals from the sensor 1020 corresponding to the contour and size of the workpiece 1018 (FIG. 32) and subsequently generates output signals that controls the path of the cutting attachment 1058.

During operation, a user simply inserts the workpiece 1018 into tool body 1012 via the opening 1016 so that the workpiece 1018 is consistently located within the tool body 1012. Next, the cutting attachment 1058 performs the optimal coping cut 1014 based on information that the sensor 1020 gathers from analyzing the workpiece. The illustrated embodiment creates a system where the user needs no prior knowledge of coping and the tool path for the optimal coping cut can be repeated numerous times on new workpieces.

Various features of the invention are set forth in the following claims.

1. A power tool used to perform a coping cut, the power tool comprising:
a main housing;
a motor disposed within the main housing;
a drive shaft driven by the motor about a rotational axis;
a handle extending from the main housing; and
an abrasive disc coupled to and driven by the drive shaft about the rotational axis, the abrasive disc having an outer diameter of at least 3 inches,
wherein the motor is an outer rotor brushless direct current motor capable of rotating at 4,000 surface feet per minute at 1.5 inch-pounds of torque.

2. The power tool of claim 1, further comprising a battery that is removably coupled to the handle and configured to provide power to the motor.

3. The power tool of claim 1, further comprising a tool chuck on the drive shaft that receives the abrasive disc, such that the drive shaft provides a direct drive from the motor to the abrasive disc.

4. The power tool of claim 1, further comprising a fan disposed within the main housing between the abrasive disc and the motor, wherein the fan is driven by the drive shaft to induce an airflow.

5. The power tool of claim 4, wherein the fan is coupled to the drive shaft.

6. The power tool of claim 4, wherein the fan is coupled to a spindle of the abrasive disc.

7. The power tool of claim 4, wherein the fan is integrated with the abrasive disc.

8. The power tool of claim 4, further comprising a dust shroud coupled to the main housing and disposed at least partially around the abrasive disc.

9. The power tool of claim 8, wherein the airflow induced by the fan flows into the dust shroud, around the abrasive disc, and through an outlet port that is in fluid communication with a dust collector.

10. The power tool of claim 8, wherein the dust shroud includes a cut zone opening where the abrasive disc is exposed, allowing a workpiece to pass through and engage the abrasive disc.

11. The power tool of claim 10, wherein the dust shroud includes a movable segment operable to vary a size and/or shape of the cut zone opening.

12. A coping tool comprising:
a main housing;
a motor disposed within the main housing that rotates about a rotational axis;
a handle extending from the main housing;
an abrasive disc coupled to and driven by the motor about the rotational axis; and
a dust shroud coupled to the main housing and disposed at least partially around the abrasive disc, the dust shroud including
a channel extending along the dust shroud adjacent the abrasive disc, and
a cut zone opening through which a workpiece may pass to engage the abrasive disc,
wherein the channel is U-shaped and surrounds an outer periphery of the abrasive disc, and
wherein the cut zone opening is adjustable in size and/or shape to accommodate the workpiece.

13. The coping tool of claim 12, wherein dust and debris are generated from the workpiece during a coping operation, which travels tangentially from the abrasive disc into the channel of the dust shroud and towards an outlet port that is in fluid communication with a dust collector.

14. The coping tool of claim 12, wherein the dust shroud includes a plurality of movable segments operable to vary a size and/or shape of the cut zone opening.

15. The coping tool of claim 14, wherein the plurality of movable segments are moveable between a first position where the abrasive disc is substantially covered and a second position where the abrasive disc is at least partially exposed, wherein the plurality of movable segments are biased toward the first position.

16. The coping tool of claim 14, wherein the plurality of movable segments are telescopically connected together and nested within each other when moved to the second position.

17. A coping tool comprising:
a main housing;
a motor disposed within the main housing that rotates about a rotational axis;
a handle extending from the main housing;
an abrasive disc coupled to and driven by the motor about the rotational axis;
a fan disposed within the main housing and configured to induce an airflow; and
a dust shroud pivotably coupled to the main housing and disposed at least partially around the abrasive disc, the dust shroud including
a channel extending along the dust shroud, and
a cut zone opening through which a workpiece may pass to engage the abrasive disc,
wherein the cut zone opening is adjustable in size and/or shape in response to the dust shroud pivoting between a first position and a second position.

18. The coping tool of claim 17, wherein the channel is U-shaped and surrounds an outer periphery of the abrasive disc.

19. The coping tool of claim 18, wherein the dust shroud is adjacent the abrasive disc in the first position, such that the channel receives the abrasive disc, wherein the dust shroud is spaced away from the abrasive disc in the second position, and wherein the dust shroud is biased toward the first position.

20. The coping tool of claim 19, wherein dust and debris are generated from the workpiece during a coping operation travels through the channel of the dust shroud and along the airflow toward an outlet port that is in fluid communication with a dust collector.
